(19) United States
(12) Patent Application Publication
(10) Pub. No.: US 2024/0213904 A1
(43) Pub. Date: Jun. 27, 2024

(54) INVERTER FOR AN ELECTRIC MACHINE

(71) Applicant: Valeo eAutomotive France SAS, Cergy Pontoise (FR)

(72) Inventors: Eloi MORTAIN, Cergy Pontoise (FR); Aurélien POUILLY, Cergy Pontoise (FR); Amaury ROUET, Cergy Pontoise (FR); Sreenath NARAYANAN, Chennai (IN)

(73) Assignee: Valeo eAutomotive France SAS, Cergy Pontoise (FR)

(21) Appl. No.: 18/390,862

(22) Filed: Dec. 20, 2023

(30) Foreign Application Priority Data
Dec. 22, 2022 (FR) 22 14296

(51) Int. Cl. H02P 27/06; B60L 15/00

(52) U.S. Cl. CPC H02P 27/06; B60L 15/007; B60L 2210/40

(57) ABSTRACT

An inverter includes a capacitive module and a first power module connected to the capacitive module by a first DC connection and includes a first AC connection arranged on an opposite side of the first power module. A second power module is connected to the capacitive module by a second DC connection and includes a second AC connection arranged on an opposite side of the second power module. The power modules are arranged on the same side of the capacitive module, on either side of a median plane of the capacitive module, the AC connections being closer to the median plane of the capacitive module than the DC connections.

### TECHNICAL FIELD

The present invention relates to electrical equipment such as inverters, equipped with power modules and associated with an electric machine, for example an engine of an electric or hybrid vehicle.

### PRIOR ART

As is known, an electric or hybrid motor vehicle comprises an electric drive system supplied with power by a high-voltage supply battery, the voltage of which is generally greater than 100 V, via a high-voltage on-board electrical system and a plurality of auxiliary electrical equipment items supplied with power by a low-voltage supply battery via a low-voltage on-board electrical system. The high-voltage supply battery provides a function of supplying energy to the electric drive system, allowing the vehicle to be propelled. More precisely, in order to control the electric machine driving the wheels of the vehicle, it is known to use an inverter for converting the DC voltage delivered by the high-voltage supply battery into one or more AC control voltages, for example sinusoidal ones.

It is also known to integrate, into the inverter, a capacitive filtering device, known as a link capacitor or DC-link capacitor to a person skilled in the art, having the role in particular of stabilizing the voltage delivered to the active power electronics component of the inverter, in particular a power module supplying electrical energy to the electric machine.

Within the context of electric or hybrid vehicles requiring high levels of power, for example a utility vehicle, it is known to supply power to an electric machine by way of multiple power modules, generally two power modules each delivering a three-phase electric current. This architecture then generally uses two link capacitors, each connected to a power module.

The electric machine generally comprises six phases, each of the phases being supplied with one of the currents from one of the two power modules. However, this configuration has the drawback for the electric machine of having two three-phase currents arrive from independent sources and whose characteristics are different, which may result in disturbances in the operation of the electric machine, or at least generate difficulties in terms of the driving thereof. Moreover, in the case of a three-phase inverter with three phases connected to said electric machine, currents from each of the two power modules having a similar phase offset have to be associated within a connection interface in order to supply power to a phase of the electric machine, resulting in a complex architecture of the connection interface, in particular due to the presence of other components such as electronic cards fastened to the power modules. The manufacture of an inverter under these conditions thus constitutes a complex arrangement and makes driving difficult.

The invention aims to overcome the drawbacks from the prior art by proposing a simplified inverter architecture with reduced cost and with improved performance.

### PRESENTATION OF THE INVENTION

More precisely, one subject of the invention is an inverter, in particular configured to be housed on board a motor vehicle, comprising:
a capacitive module;
a first power module connected to the capacitive module by a first DC connection and comprising a first AC connection configured to carry an electric current between the capacitive module and an AC electric machine, the first AC connection being arranged on an opposite side of the first power module with respect to the first DC connection;
a second power module connected to the capacitive module by a second DC connection and comprising a second AC connection configured to carry an electric current between the capacitive module and the AC electric machine, the second AC connection being arranged on an opposite side of the second power module with respect to the second DC connection;
   the first power module and the second power module being arranged on the same side of the capacitive module, on either side of a median plane of the capacitive module, the inverter being characterized in that the first AC connection of the first power module and the second AC connection of the second power module are closer to the median plane of the capacitive module than the first DC connection and the second DC connection.

By virtue of such a combination of features, the power modules of such an inverter exhibit similar operating performance, due to a symmetrical overall arrangement of the inverter, while at the same time being connected to the same capacitive module, and are therefore supplied with the same current. The first and second AC connections are also less likely to hamper the arrangement of additional components of the inverter, such as electronic cards for driving the power modules.

Advantageously, the first AC connection of the first power module and the second AC connection of the second power module extend in the median plane of the capacitive module. In such a configuration, the two power modules are closer to one another, thereby further improving the overall compactness of the inverter.

Advantageously, the first AC connection of the first power module and the second AC connection of the second power module are pooled in a connection interface configured to supply power to an AC motor. In such a configuration, the connection interface, preferably an electrical connection bar or “busbar” for a person skilled in the art, has small dimensions for connecting to the terminals of an electric machine compared with a standard architecture, wherein the connection interfaces are pooled as close as possible to the terminals of the electric machine.

Advantageously, the first AC electrical connection comprises a plurality of first electrical connectors, and the second AC connection comprises a plurality of second electrical connectors.

Advantageously, the first connectors of the first AC connection and the second connectors of the second AC connection the electric currents of which have equal phase offset angles are associated in pairs in a connection interface, said connection interface comprising at least three outputs configured to supply power to the respective phases of a three-phase AC electric machine. In such a configuration, the phases of a three-phase electric motor are supplied with power as close as possible to the power modules, and the pairwise association of connectors having electric currents with the same phase offset under these conditions guarantees similar characteristics delivered by the two power modules.

Advantageously, the outputs of the connection interface extend parallel to the median plane of the capacitive module. In such a configuration, the orientation and the direction of the outputs of the connection interface correspond directly to an orientation and a direction of the phase connectors of an electric motor located outside the inverter.

Advantageously, the outputs of the connection interface are arranged on the same side of the first power module as the first DC connection.

Advantageously, the first power module and the second power module are identical.

Advantageously, the capacitive module is a link capacitor. In such a configuration, the DC current supplied to the two power modules comes from the same link capacitor, thereby further reinforcing the performance symmetry between the two power modules.

Advantageously, the outputs of the connection interface are arranged on the same side of the first power module as the first AC connection.

Advantageously, the inverter furthermore comprises an electronic card for driving the power modules extending perpendicular to the median plane, the connection interface then extending parallel to said electronic card between the power modules and the electronic card and the outputs of the connection interface extend parallel to the median plane, passing through an orifice for the passage of the electronic card.

According to another aspect of the invention, the invention relates to a transport machine such as an electric or hybrid vehicle.

### PRESENTATION OF THE FIGURES

The invention will be better understood on reading the following description, which is provided solely by way of example, and with reference to the attached drawings that are given by way of non-limiting examples, in which identical references are given to similar objects and in which:

FIG. 1 is a schematic perspective depiction of an inverter according to one embodiment of the invention;

FIG. 2 is a schematic front-on depiction of the inverter from FIG. 1 in the position with a frame and a cover of the inverter removed;

FIG. 3 is a schematic plan-view depiction of the inverter from FIG. 1, in the position with an electronic card removed.

It should be noted that the figures disclose the invention in detail to enable the invention to be implemented; although not limiting, said figures are used in particular to better define the invention where appropriate.

### DETAILED DESCRIPTION OF THE INVENTION

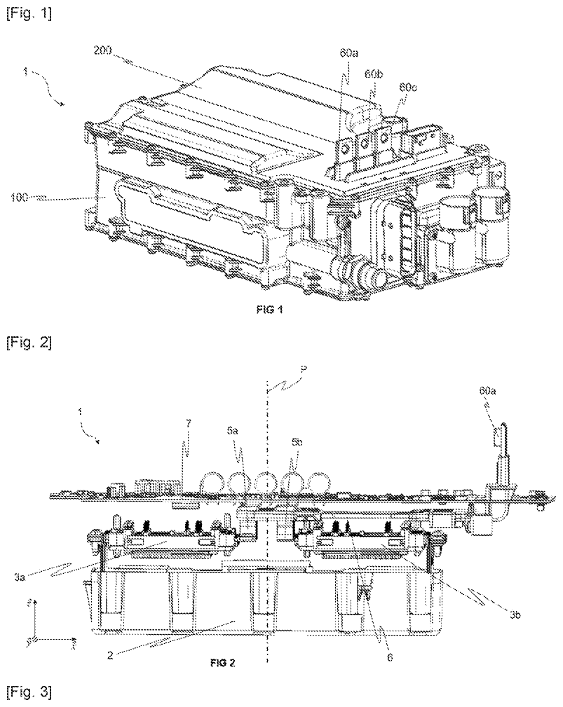

FIG. 1 illustrates an inverter 1, for example for an engine of an electric or hybrid vehicle. The inverter 1 comprises a frame 100 and a cover 200 that is detachable between a removed position, in which an internal space of the frame 100 is accessible, and a closed position, which corresponds to an operating position of the inverter 1.

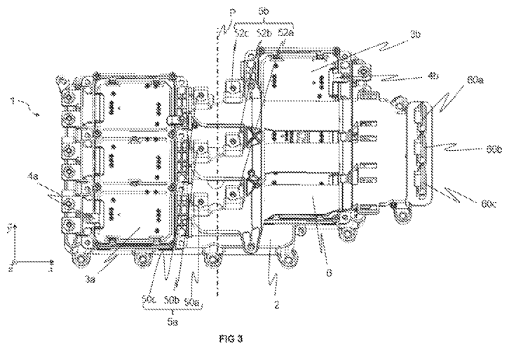

FIGS. 2 and 3 illustrate the inverter 1 in the position with the frame 100 and the cover 200 removed. The inverter 1 comprises a capacitive module 2, here a link capacitor. The link capacitor 2 has a generally substantially prismatic parallelepipedal shape, a length of the link capacitor 2 extending in a horizontal direction X, a width of the link capacitor 2 extending in a transverse direction Y and a height of the link capacitor 2 extending in a vertical direction Z. The link capacitor 2 has a median plane P extending in a vertical plane Z, Y, such that the length of the capacitor 2 corresponds to a median of the median plane P.

The inverter 1 furthermore comprises a first power module 3a connected to the link capacitor 2 by a first DC connection 4a. The term “power module” is understood to mean an assembly comprising components through which energy supplied to the electric machine passes. These components may comprise electronic switches, such as for example semiconductor transistors, arranged in an electrical circuit so as to allow a controlled passage of electrical energy between the supply battery and the electric machine. In particular, the components are bare semiconductor chips for which encapsulation is carried out. In other words, a power module is an assembly comprising a plurality of semiconductor chips that form an electrical circuit and are encapsulated in the same casing. The first power module 3a extends parallel to a plane X, Y, vertically above the link capacitor 2.

The first DC connection 4a enables the link capacitor 2 to supply a filtered and stabilized DC current to the first power module 3a. The first DC connection 4a extends vertically in the direction Z. The first power module 3a furthermore comprises a first AC connection 5a. In the embodiment described, the first AC connection 5a comprises a plurality of first electrical connectors 50a, 50b, 50c, each of the first electrical connectors 50a, 50b, 50c being supplied with an AC electric current having a different phase offset. The first connectors 50a, 50b, 50c are arranged on an opposite side of the first power module 3a with respect to the first DC connection 4a.

The inverter 1 furthermore comprises a second power module 3b connected to the link capacitor 2 by a second DC connection 4b. The second power module 3b extends parallel to the plane X, Y vertically above the link capacitor 2 on another side of the median plane P of the link capacitor 2 than the first power module 3a. Here, the first power module 3a and the second 25 power module 3b are identical.

The second DC connection 4b enables the link capacitor 2 to supply a filtered and stabilized DC current to the second power module 3b. The second DC connection 4b extends vertically in the direction Z. The second power module 3b furthermore comprises a second AC connection 5b. In the embodiment described, the second AC connection 5b comprises a plurality 30 of second electrical connectors 52a, 52b, 52c, each of the second electrical connectors 52a, 52b, 52c being supplied with an AC electric current having a different phase offset. The second connectors 52a, 52b, 52c are arranged on an opposite side of the second power module 3b with respect to the second DC connection 4b.

The first connectors 50a, 50b, 50c are closer to the median plane P of the link capacitor 2 than the first DC connection 4a. The second connectors 52a, 52b, 52c are closer to the median plane P of the link capacitor 2 than the second DC connection 4b. Due to this substantially symmetrical arrangement, the power modules 3a, 3b exhibit similar operating performance.

The first connectors 50a, 50b, 50c and the second connectors 52a, 52b, 52c the electric currents of which have equal phase offset angles are associated in pairs in a connection interface 6 comprising three outputs 60a, 60b, 60c that are configured to supply power to the respective phases of a three-phase AC motor. In the embodiment described, the connection interface 6 is an electrical connection bar, or “busbar” for a person skilled in the art. The connection interface 6 extends perpendicular to the median plane P of the link capacitor 2 and the outputs of the connection interface 60a, 60b, 60c extend parallel to the median plane P and on the side of the second DC connection 4b. Advantageously, the outputs of the connection interface 60a, 60b, 60c are arranged on the side of the first DC connection 4a.

In particular, the first AC connection 5a of the first power module 3a and the second AC connection 5b of the second power module 3b extend in the median plane P. In this case, the power modules 3a, 3b exhibit even more similar, in particular substantially identical, operating performance.

FIG. 2 differs from FIG. 3 in that FIG. 2 illustrates an electronic card 7 extending perpendicular to the median plane P. The electronic card 7 is located vertically above the control modules 3a, 3b, and the connection interface 6 extends between the power modules 3a, 3b and the electronic card 7. The outputs of the connection interface 60a, 60b, 60c also extend through an orifice for the passage of the electronic card 7.

It will also be noted that the invention is not limited to the embodiments described above. Indeed, it will be apparent to a person skilled in art that various modifications may be made to the embodiment described above, in the light of the teaching just disclosed to them.

In the detailed presentation of the invention provided above, the terms that are used should not be interpreted as limiting the invention to the embodiment disclosed in the present description, but should be interpreted so as to include all equivalents the provision of which is within the capabilities of a person skilled in the art by applying their general knowledge to the implementation of the teaching that has just been disclosed to them.

1. Inverter, in particular configured to be housed on board a motor vehicle, comprising:
a capacitive module;
a first power module connected to the capacitive module by a first DC connection and comprising a first AC connection configured to carry an electric current between the capacitive module and an AC electric machine, the first AC connection being arranged on an opposite side of the first power module with respect to the first DC connection;
a second power module connected to the capacitive module by a second DC connection and comprising a second AC connection configured to carry an electric current between the capacitive module and the AC electric machine, the second AC connection being arranged on an opposite side of the second power module with respect to the second DC connection;
the first power module and the second power module being arranged on the same side of the capacitive module, on either side of a median plane of the capacitive module, the inverter being characterized in that the first AC connection of the first power module and the second AC connection of the second power module are closer to the median plane of the capacitive module than the first DC connection and the second DC connection.

2. Inverter according to claim 1, wherein the first AC connection of the first power module and the second AC connection of the second power module extend in the median plane of the capacitive module.

3. Inverter according to claim 1, wherein the first AC connection of the first power module and the second AC connection of the second power module are pooled in a connection interface configured to supply power to an AC motor.

4. Inverter according to claim 1, wherein the first AC electrical connection comprises a plurality of first electrical connectors, and the second AC connection comprises a plurality of second electrical connectors.

5. Inverter according to claim 4, wherein the first connectors of the first AC connection and the second connectors of the second AC connection the electric currents of which have equal phase offset angles are associated in pairs in a connection interface, said connection interface comprising at least three outputs configured to supply power to the respective phases of a three-phase AC motor.

6. Inverter according to claim 5, wherein the outputs of the connection interface extend parallel to the median plane of the capacitive module.

7. Inverter according to claim 5, wherein the outputs of the connection interface are arranged on the same side of the first power module as the first DC connection.

8. Inverter according to claim 1, wherein the first power module and the second power module are identical.

9. Inverter according to claim 1, wherein the capacitive module is a link capacitor.

10. Transport machine, wherein it comprises an inverter according to claim 1.

11. Inverter according to claim 2, wherein the first AC connection of the first power module and the second AC connection of the second power module are pooled in a connection interface configured to supply power to an AC motor.

12. Inverter according to claim 2, wherein the first AC electrical connection comprises a plurality of first electrical connectors, and the second AC connection comprises a plurality of second electrical connectors.

13. Inverter according to claim 6, wherein the outputs of the connection interface are arranged on the same side of the first power module as the first DC connection.

14. Inverter according to claim 2, wherein the first power module and the second power module are identical.

15. Inverter according to claim 2, wherein the capacitive module is a link capacitor.

16. Transport machine, wherein it comprises an inverter according to claim 2.

17. Inverter according to claim 3, wherein the first AC electrical connection comprises a plurality of first electrical connectors, and the second AC connection comprises a plurality of second electrical connectors.

18. Inverter according to claim 3, wherein the first power module and the second power module are identical.

19. Inverter according to claim 3, wherein the capacitive module is a link capacitor.

20. Transport machine, wherein it comprises an inverter according to claim 3.
